(19) United States
(12) Patent Application Publication
(10) Pub. No.: US 2024/0161721 A1
(43) Pub. Date: May 16, 2024

(54) MOVEMENT-BASED AUDIO OUTPUT FOR ELECTRONIC DEVICES

(71) Applicant: Apple Inc., Cupertino, CA (US)

(72) Inventors: Bryan G. LANSER, Cupertino, CA (US); Aram M. LINDAHL, Menlo Park, CA (US); Tony S. VERMA, San Francisco, CA (US)

(21) Appl. No.: 17/986,868

(22) Filed: Nov. 14, 2022

(51) Int. Cl. G10H 7/00

(52) U.S. Cl. CPC G10H 7/00; G10H 2210/375; G10H 2220/201; G10H 2240/211

(57) ABSTRACT

Systems, devices, and methods for motion-based output of audio content are provided. The motion-based output of audio content may include synchronizing a tempo and a phase of audio content being output with a cadence and a phase of a cyclic movement of a user of an electronic device. The motion-based output can be performed by a system-level process such that synchronizations to motion cadence and phase can be provided for local audio content and/or audio content from any of various content streaming sources. The motion-based output can also account for algorithmic and/or transmission latencies, to output beats of the audio content in sync with user footfalls, including in implementations in which wireless headphones or earbuds are used. Tempo and phase matching can also be provided across a delay or interval in which there is no output of audio content, such as during the gap between adjacent songs in a playlist.

### TECHNICAL FIELD

The present description relates generally to electronic devices including, for example, to movement-based audio output for electronic devices.

### BACKGROUND

Electronic devices are often used to output music from a speaker of the electronic device. The music can be stored at an electronic device for output, or can be streamed from a streaming service at the time of output. In conventional music output or playback, the music is output with a fixed tempo that determined entirely by the stored recording of the music.

### BRIEF DESCRIPTION OF THE DRAWINGS

Certain features of the subject technology are set forth in the appended claims. However, for purpose of explanation, several aspects of the subject technology are set forth in the following figures.

FIG. 1 illustrates an example system architecture including various electronic devices that may implement the subject system in accordance with one or more implementations.

FIG. 2 illustrates an example of an output of audio content with a fixed tempo and an arbitrary fixed phase in accordance with implementations of the subject technology.

FIG. 3 illustrates an example of an output of audio content with an adjusted tempo and an arbitrary fixed phase in accordance with implementations of the subject technology.

FIG. 4 illustrates an example of an output of audio content with an adjusted tempo and a phase that is phase-matched to user footfalls in accordance with implementations of the subject technology.

FIG. 5 is a schematic diagram illustrating process for providing movement-based audio output in accordance with implementations of the subject technology.

FIG. 6 illustrates a flow diagram for an example process for movement-based audio output in accordance with implementations of the subject technology.

FIG. 7 illustrates a flow diagram for an example process that may be performed by an application for movement-based audio output in accordance with implementations of the subject technology.

FIG. 8 illustrates a flow diagram for an example process for movement-based audio output of audio content from multiple different content sources in accordance with implementations of the subject technology.

FIG. 9 illustrates a flow diagram for an example process for content curation in accordance with implementations of the subject technology.

FIG. 10 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the subject disclosure can provide audio content that synchronizes to the cadence of a cyclic movement of a user. For example, music can be synchronized (e.g., tempo-match and/or phase-matched) to the cadence of a walking movement, a jogging movement, a running movement, a dancing movement, a cycling movement, a swimming movement, a vacuuming, scrubbing, hammering, sawing, raking, sweeping or other household maintenance, gardening, or construction movement, a gymnastics movement, or any other cyclic movement of user that can be detected by an electronic device (e.g., by a sensor of the electronic device). For example, a song can be selected and/or modified so that beats of the song are output by a speaker at the same times as footfalls of a walking, running, or cycling user. Modifications to the songs can include tempo modifications and/or phase modifications for matching to the cadence and/or phase of the cyclic movement of the user.

In one or more use cases that are described herein as examples, an electronic device (e.g., a smartphone, a smart watch, a tablet device, or other portable electronic device that can be worn or carried by a user) transmits audio content to a wireless media output device (e.g., wireless headphones or earbuds, such as Bluetooth headphones or earbuds) for output by a speaker of the wireless media output device. In these use cases, the output of the audio content may be based, at least in part, on a transmission latency (e.g., a Bluetooth latency) between the wireless media output and the electronic device that is transmitting audio content to the wireless media output device. In this way, the electronic device and/or the media output device can compensate for the transmission latency (and/or other algorithmic latencies for performing audio content modifications), to output the audio content in both tempo phase synchronization with the cyclic movement of the user.

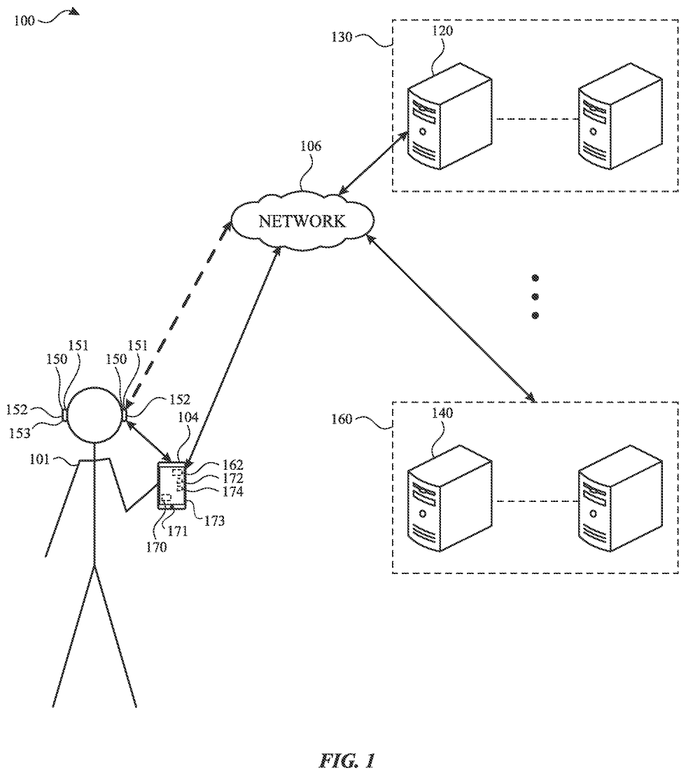

FIG. 1 illustrates an example system architecture 100 including various electronic devices that may implement the subject system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The system architecture 100 includes a media output device 150, an electronic device 104 (e.g., a handheld electronic device such as a smartphone or a tablet, or a wearable electronic device such as a smart watch or a head worn device), one or more servers 120, one or more servers 140 communicatively coupled by a network 106 (e.g., a local or wide area network). For explanatory purposes, the system architecture 100 is illustrated in FIG. 1 as including the media output device 150, the electronic device 104, the server(s) 120, and the server(s) 140; however, the system architecture 100 may include any number of electronic and/or audio devices and any number of servers and/or a data centers including multiple servers.

The media output device 150 may be implemented as a wireless audio output device such as a smart speaker, or headphones (e.g., a pair of speakers mounted in speaker housings that are coupled together by a headband) or an earbud (e.g., an earbud of a pair of earbuds each having a speaker disposed in a housing that conforms to a portion of the user's ear) configured to be worn by a user 101 (also referred to as a wearer when the wireless audio output device is worn by the user), or may be implemented as any other device capable of outputting audio and/or video and/or other types of media (e.g., and configured to be worn by a user). Each media output device 150 may include one or more audio output components such as speaker 151 configured to project sound into an ear of the user 101, and one or more sensors, such as sensors 152. The media output device 150 may be communicatively coupled to the electric device 104 via the network 106 or via a wireless connection or a direct wireless, such as a Bluetooth connection or a direct WiFi connection. In one or more implementations, the media output device 150 may be communicatively coupled to the network 106 via the connection with the electric device 104. In one or more other implementations, the media output device 150 may optionally be capable of connecting directly to the network 106 (e.g., without a connection to the electronic device 104).

In one or more implementations, sensors 152 may include motion sensors configured to obtain motion sensor data indicating motion of the media output device 150 and/or motion of the user/wearer of the media output device 150. For example, the sensors 152 may include one or more inertial measurement sensors (e.g., one or more accelerometers and/or one or more gyroscopes) that measure the motion of the media output device 150 itself (e.g., motion of the media output device 150 due to motion of a user/wearer of the media output device while carrying or wearing the media output device 150, such as while performing a cyclic movement such as a running or walking movement) and/or one or more remote sensors (e.g., image-based sensors, radar sensors, lidar sensors, time-of-flight sensors) configured to measure motion of a user that is separate from motion of the media output device 150 (e.g., a dancing movement of a user that is within the range of one or more of the motion sensors, such as in a room in which a smart speaker having remote motion sensors is located).

In one or more implementations, the media output device 150 may also include other components, such as one or more microphones and/or one or more display components (not shown) for displaying video or other media to a user. Although not visible in FIG. 1, each media output device 150 may include processing circuitry (e.g., including memory and/or one or more processors) and communications circuitry (e.g., one or more antennas, etc.) for receiving and/or processing audio content from the electronic device 104 or another electronic device. The processing circuitry of the media output device 150 may operate the speaker 151 to generate sound (also referred to herein as audio output) corresponding to the audio content received from the electronic device 104. The media output device may include a power source such as a battery and/or a wired or wireless power source.

The media output device 150 may include communications circuitry for communications (e.g., directly or via network 106) with the electronic device 104, the server 120, and/or the server 140, the communications circuitry including, for example, one or more wireless interfaces, such as WLAN radios, cellular radios, Bluetooth radios, Zigbee radios, near field communication (NFC) radios, and/or other wireless radios. The electronic device 104, the server 120, and/or the server 140 may include communications circuitry for communications (e.g., directly or via network 106) with media output device 150 and/or with the others of the electronic device 104, the server 120, and/or the server 140, the communications circuitry including, for example, one or more wireless interfaces, such as WLAN radios, cellular radios, Bluetooth radios, Zigbee radios, near field communication (NFC) radios, and/or other wireless radios.

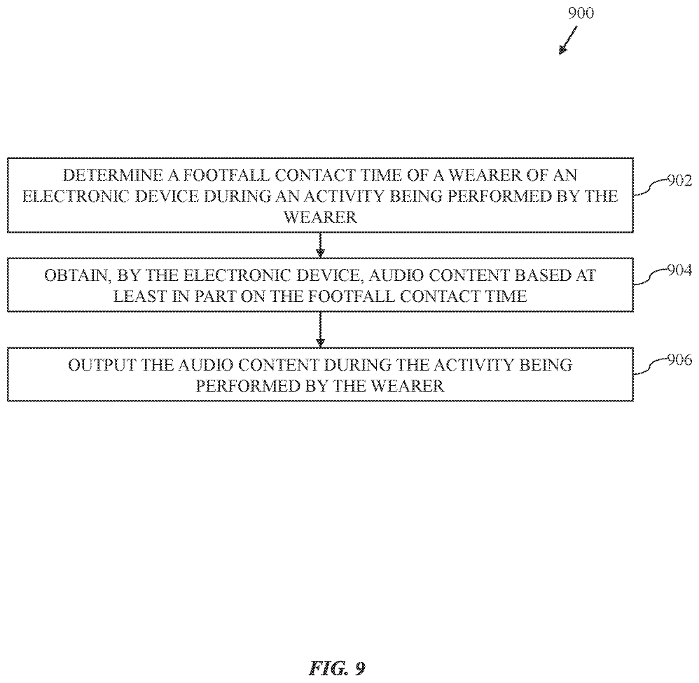

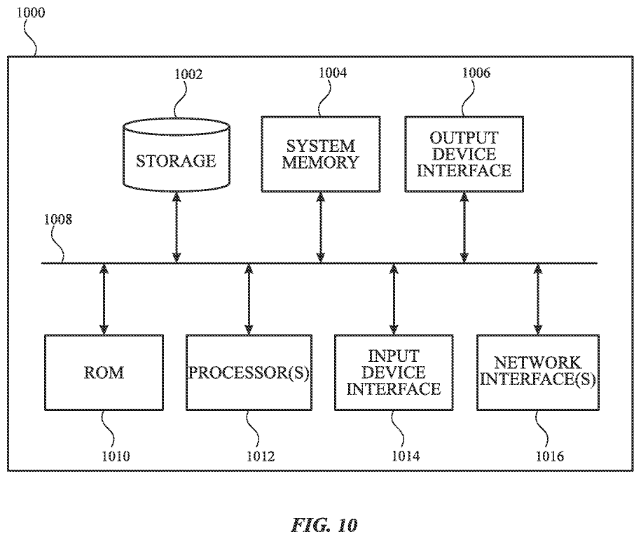

The electronic device 104 may be, for example, a smartphone, a portable computing device such as a laptop computer, a peripheral device (e.g., a digital camera, headphones, another audio device, or another media output device), a tablet device, a wearable device such as a smart watch, a smart band, a head wearable device, and the like, any other appropriate device that includes, for example, processing circuitry and/or communications circuitry for providing audio content to media output device(s) 150. In FIG. 1, by way of example, the electronic device 104 is depicted as a mobile smartphone device. In one or more implementations, the electronic device 104 and/or the media output device 150 may be, and/or may include all or part of, the electronic device discussed below with respect to the electronic system discussed below with respect to FIG. 9. As shown in FIG. 1, the electronic device 104 may including a housing 173, and the memory 162, the speaker 171 (e.g., and/or one or more other audio output components including other speakers), the sensor(s) 170, and/or other components (e.g., processors, displays, batteries, etc.) may be disposed within and/or otherwise mounted to the housing 173 of the electronic device. As shown in FIG. 1, the media output device 150 may include a housing 153 that is physically separate from the housing 173 of the electronic device, and the speaker(s) 151 and/or the sensors 152 (e.g., and/or other components such as memory, processor(s), communications circuitry, or the like) may be disposed within or otherwise mounted to the housing 173.

As shown in FIG. 1, the electronic device 104 may include one or more audio output components such as speaker 171 and/or memory 162 (e.g., volatile or non-volatile memory). Memory 162 may store audio content, such as a music library containing one or more audio files, each corresponding to a song or other rhythmic audio content. For example, songs stored in the memory 162 may have been downloaded from a remote service (e.g., a first remote service 130 hosted by the server(s) 120 or a second remote service (e.g., a second remote service 160 hosted by the server(s) 140), or uploaded to the memory 162 from another electronic device or storage medium. Audio content, such as a song, stored in the memory 162 may have an initial tempo. For example, the initial tempo may be tempo at which the song was recorded, and the tempo at which the song will be output if no modifications are made. It is appreciated that the “initial tempo” of a song may vary within the song (e.g., a song may have portions that were recorded for playback at a higher or lower tempo than the other portions of the song), but may still be referred to herein as “initial” until the tempo is modified and/or adjusted according to motion information as described herein.

As illustrated in FIG. 1, the electronic device 104 may run one or more system processes 172 and/or one or more application processes (e.g., applications 174). In one or more implementations, system processes 172 may provide motion-based audio output of audio content that is provided by one or more applications 174, and/or system processes 172 may provide motion information and/or other information (e.g., information associated with a transmission latency to the media output device 150) to the application(s) 174 for performing motion-based audio operations at an application 174. Although a single system process 172 and a single application 174 are shown in FIG. 1, it is appreciated that multiple system processes 172 and/or multiple applications 174 may run on the electronic device 104 at concurrent or different times. As examples, the applications 174 may include media player applications or media service applications (e.g., each associated with a remote service, such as the first remote service 130 or the second remote service 160), fitness applications that can be used to play audio content during a workout or activity, or any other application that can be used to output audio content. For example, a fitness application may provide a user with an option to play music or other audio content during a workout that is being tracked by the fitness application. A media player application, a fitness application, or any other application that can be used to output audio content may also provide the user with an option to synchronize the tempo and the phase of the music or other audio content with a cyclic motion of the user while the music or other audio content is playing. In one or more implementations, an application, such as a fitness application may be provided with the ability, using the operations described hereinafter, to increase or decrease the tempo of the music or other audio content to encourage the user to increase or decrease a workout pace or to increase or decrease their heartrate to a target heartrate.

In one or more implementations, the electronic device 104 and/or the media output device 150 may stream audio content from one or more remote services, such as the first remote service 130 and the second remote service 160 of FIG. 1. In one or more implementations, the first remote service 130 and the second remote service 160 may each be accessible via a corresponding application installed on the electronic device 104. Examples of remote services that can provide streaming music via an application at the electronic device include, but are not limited to, Pandora®, Apple Music®, Spotify®, Tidal®, Amazon Music®, and YouTube Music®. In one or more implementations, audio content may be obtained by the electronic device 104 from the first remote service 130, the second remote service 160, any other remote service, and/or the memory 162, and modified, based on motion information, for output (e.g., by a speaker of the electronic device 104 itself or by a speaker of the media output device 150).

In one or more implementations, a transmission latency or connection latency can delay the output of audio content provided from the electronic device 104 to the media output device 150 for output. The transmission latency may be higher for wireless connections between the media output device 150 and the electronic device 104 than for wired connections between the media output device 150 and the electronic device 104. In one or more implementations, the transmission latency can be determined by the electronic device 104, or by the media output device 150 and published to the electronic device 104 (e.g., to a system process 172 at the electronic device 104). In one or more implementations, the electronic device 104 may provide audio content to the media output device 150, advanced in time, to compensate for the transmission latency. In this way, the audio content can be output in phase with a cyclic movement of a user of the electronic device 104 and/or the media output device 150.

As shown in FIG. 1, the electronic device 104 may include one or more sensors, such as sensors 170. In one or more implementations, sensors 170 may include motion sensors configured to obtain motion sensor data that reflects motion(s) of the electronic device 104 and/or motion(s) of the user/wearer of the electronic device 104. For example, the sensors 170 may include one or more inertial measurement sensors (e.g., one or more accelerometers and/or one or more gyroscopes) that measure the motion of the electronic device 104 itself (e.g., motion of the electronic device 104 that is due to motion of a user/wearer of the media output device while carrying or wearing the electronic device 104) and/or one or more remote sensors (e.g., image-based sensors, radar sensors, lidar sensors, time-of-flight sensors, or the like) configured to measure motion of a user that is separate from motion of the electronic device 104 (e.g., a dancing movement of the user that is within the range of one or more of the sensors 170, such as in a room in which the electronic device 104 is located).

The server(s) 120 may form all or part of a network of computers or a group of servers for the first remote service 130, such as in a cloud computing or data center implementation. For example, the server(s) 120 may store data (e.g., audio content) and software, and include specific hardware (e.g., processors, graphics processors and other specialized or custom processors) storing, curating, and/or streaming audio content to network-connected devices, such as the electronic device 104. The server(s) 140 may form all or part of a network of computers or a group of servers for the second remote service 160, such as in a cloud computing or data center implementation. For example, the server(s) 140 may store data (e.g., audio content) and software, and include specific hardware (e.g., processors, graphics processors and other specialized or custom processors) storing, curating, and/or streaming audio content to network-connected devices, such as the electronic device 104.

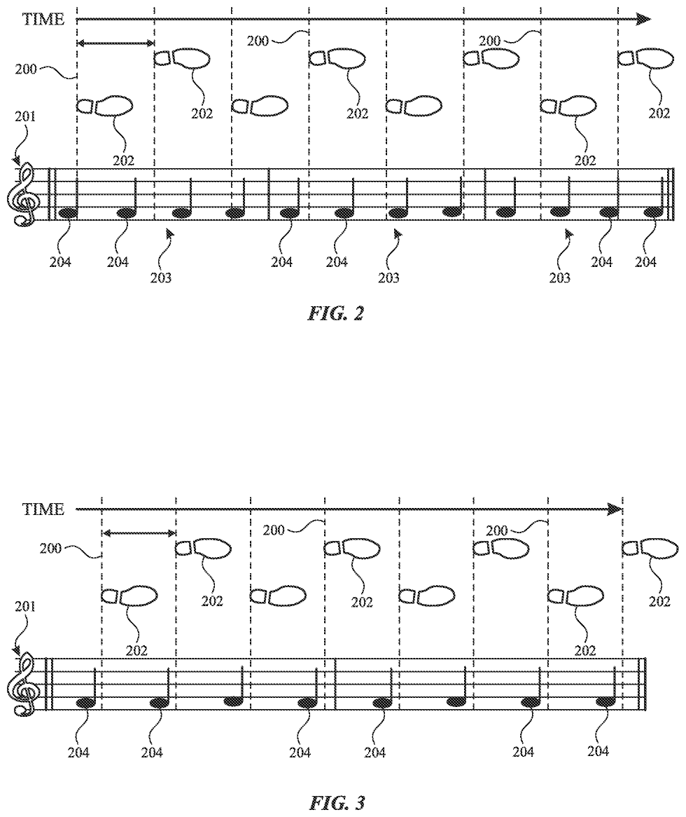

FIG. 2 illustrates aspects of an example use case in which audio content 201 is output concurrently with a cyclic movement of a user. In this example, the cyclic movement of the user is represented by footfalls 202 (e.g., contacts between a foot of the user and the ground on which the user is walking or running) that occur cyclically at respective footfall times 200. In the example use case of FIG. 2, the footfalls 202 may occur with a footfall cadence (e.g., a number of footfalls per unit time, that can be determined by the footfall times 200). For convenience of the present discussion, a unit time may correspond to a measure 203 of the audio content 201. It is also appreciated that, although footfalls of a walking or running movement are discussed, in other use cases, other cyclic movements of a user (e.g., arm circles or body rotations during a dancing movement) can occur with another motion cadence corresponding to a number of cycles of that cyclic movement per unit time.

Beats 204 of the audio content (indicated, for illustrative purposes, by musical notes on a treble clef in FIG. 2) occur with a tempo (e.g., a number of beats 204 per unit time, such as a number of the beats 204 per measure 203) of the audio content 201. For example, in one or more implementations, a tempo of audio content, such as a song or other rhythmic audio content (e.g., a poem), may be a number of beats per unit time (e.g., beats per minute, beats per second, or beats per measure) that occur during recording of, and/or during playback or output of the audio content. A beat of the audio content may be a main rhythmic unit of a measure 203 of the audio content. For example, in audio content recorded in 4/4 time, there are four beats per measure (e.g., a measure may correspond to a unit of time), and a quarter note corresponds to one beat. Although FIG. 2 illustrates a single musical note at each beat, there may be many, one, or no musical notes or other content at any particular beat for a given song or other audio content. In one or more examples, a downbeat may be referred to herein as a first beat in a measure of the audio content.

In the example of FIG. 2, a user of an electronic device may be walking or running, and may initiate output (e.g., playback) of a song corresponding to the audio content 201. As shown in this example, the audio content 201 is output with its initial cadence, and without any dependence on, or information about, the footfalls 202. In this example of FIG. 2, the beats 204 are therefore generally unaligned to various degrees with the footfall times 200. However, as many users have experienced, it can be more pleasant and/or even more motivating to listen to audio content that is in sync with the user's movement (which can happen by accident for brief periods of time, or by the user adjusting their own movement to match the music).

Aspects of the subject technology may adjust the output of audio content to synchronize the audio content with detected movement of the user (e.g., detected using the sensor(s) 152 of a media output device 150 and/or the sensor(s) 170 of an electronic device 104), without, for example, the user modifying their own movement to match the audio content.

For example, FIG. 3 illustrates a use case in which the tempo of the audio content 201 has been adjusted to an adjusted tempo that matches the footfall cadence of the footfalls 202. For example, the electronic device 104 may identify, based on motion sensor information obtained from the sensor(s) 170 and/or one or more sensors of one or more other devices, the footfall times 200 of the footfalls 202. The electronic device 104 may determine the motion cadence of the user's movement based at least in part on the identified footfall times 200 (e.g., by determining the number of footfalls per unit time). The electronic device 104 may then modify the tempo of the audio content for output, to a tempo that matches (e.g., is the same as or an integer multiple of) the determined motion cadence. In various implementations, modifying the tempo of audio content can occur upon output (e.g., by speeding up or slowing down the output of the audio content) and/or can include a modification of the audio content itself prior to output. For example, modifying the audio content can include applying time compression or time expansion operations to the audio content that speed or slow the tempo while maintaining the overall sound (e.g., including maintaining the pitch of the notes) of the audio content. In one or more implementations, modifying the audio content may also include performing tempo slewing to smoothly adjust to variations in the motion cadence during the user's movement. In use cases in which the audio content itself is modified, the modifications may be performed in accordance with applicable copyright laws and with explicit permission from the owner, creator, artist, and/or originator of the audio content, as applicable.

As shown in FIG. 3, by matching the tempo of the audio content to the footfall cadence, the period and/or frequency of the beats 204 can be the same as that of the user's motion. In the example of FIG. 3, the user's movements (e.g., the footfalls 202) have not changed relative to the example of FIG. 2. Instead, it is the output of the audio content 201 that has changed based on the user's movements. However, FIG. 3 also illustrates how tempo matching alone can leave the beats 204 unaligned with the footfall times 200, even when the period and/or frequency of the beats 204 can be the same as that of the user's motion (e.g., the beats may be misaligned with the footfalls by a constant amount, in contrast with the example of FIG. 2 in which the beats are misaligned by varying amounts).

Aspects of the subject technology can provide motion-based phase matching of audio content, such as to align the beats 204 of the audio content 201 with the footfall times 200 (or with other cyclic movements of a user).

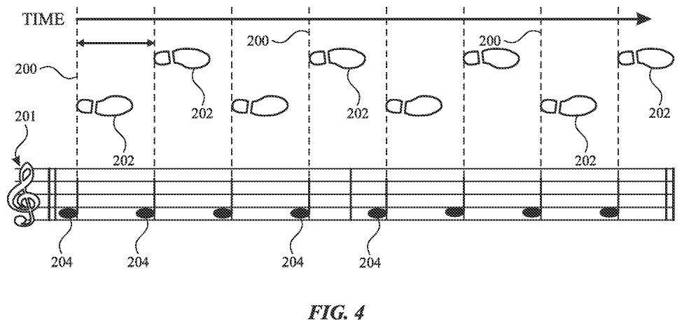

For example, FIG. 4 illustrates a use case in which motion-based tempo matching and phase matching have been applied to the audio content 201. For example, the electronic device 104 may determine a motion phase of the user's motion (e.g., a motion phase of footfalls 202) based at least in part on the identified footfall times 200 from the motion sensor information. For example, determining the motion phase may include determining the absolute times of the footfalls 202, and predicting, based on the absolute times and the determined motion tempo, absolute times of upcoming footfalls of the user. The electronic device 104 may then modify or schedule the output of the audio content such that, when the audio content is output, the beats 204 occur at the footfall times 200, as shown in FIG. 4.

As discussed herein, in one or more implementations modifying or scheduling the output of the audio content such that, when the audio content is output, the beats 204 occur at the footfall times 200 can include advancing the output, in time, to compensate for algorithmic (e.g., motion-based processing) latencies and/or transmission latencies to output devices. For example, the electronic device 104 may transmit the audio content to the media output device 150 advanced, in time, by an amount of a transmission latency to the media output device 150, so that when the media output device 150 outputs the audio content, the transmission latency is compensated and the beats 204 occur at the footfall times 200 (e.g., rather than delayed from the footfall times by the time corresponding to the transmission latency).

For example, in implementations in which the media output device 150 is connected to the electronic device 104 by a Bluetooth connection, the transmission latency may be as much as or more than 100-200 milliseconds, which may be an undesirable and noticeable delay for a user. In other use cases, such as in a use case in which the media output device 150 is connected to the electronic device 104 by a wired connection, the transmission latency may be significantly smaller than 100-200 milliseconds, but can still be large enough to be compensated for phase matching to footfalls, as described herein. Moreover, algorithmic latencies may be independent of whether the connection is a wired or wireless connection, and can be compensated for phase matching to footfalls, as described herein, irrespective of the type of connection. In one or more implementations, the transmission latency can be published to the electronic device 104 from the media output device 150 once (e.g., at the initiation of the wireless connection) or can be updated periodically or when a change in the connection configuration (e.g., the distance between the devices, wired to wireless, wireless to wired) changes. In one or more implementations, the beat alignment (e.g., phase matching) of FIG. 4 can be applied across tracks of a playlist, so that when one tempo-aligned and phase-aligned song or track ends, the next song or track is also tempo-aligned and phase-aligned with the cyclic movement of the user. For example, the media output device 150 and/or the electronic device 104 may implement a look-ahead buffer in which upcoming tempo-aligned and phase-aligned content can be stored in advance of output. In this way, the beginning of a next track can be tempo-aligned and phase-aligned and stored in the look-ahead buffer while the end of a currently playing tempo-aligned and phase-aligned track is output. When the output of the currently playing track ends, the tempo-aligned and phase-aligned beginning of the next track can be output from the look-ahead buffer. In this way, the media output device 150 and/or the electronic device 104 may maintain alignment of the beats of the audio content with the cyclic motion of the user over the gaps between musical or rhythmic pieces. This can help to provide continuity over the gaps in a playlist, download delays, etc.

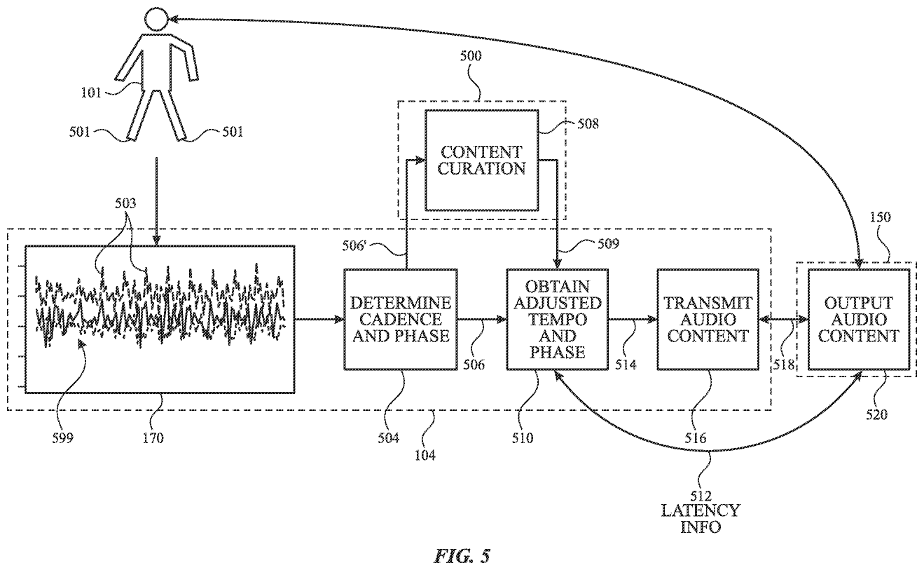

FIG. 5 illustrates an example process that can be performed for motion-based audio output, in accordance with one or more implementations. As shown in FIG. 5, sensor data 599 from the sensor(s) 170 of the electronic device 104 may be used to determine (504) a motion cadence and a motion phase of a cyclic movement (e.g., walking, running, jogging, dancing) of a user 101. For example, footfalls 501 of the user 101 may generate peaks 503 or other characteristic sensor features in the sensor data 599. In one or more implementations, determining the motion cadence and the motion phase may include identifying (e.g., using rules-based or machine learning detection operations) the peaks 503 in the sensor data 599 that correspond to footfalls 501, determining a number of the peaks 503 per unit time, determining the absolute times of the peaks 503, determining a motion cadence corresponding to the number of the peaks 503 per unit time, and/or determining a motion phase corresponding to the absolute times of the peaks 503. In one or more implementations, determining the motion phase may include predicting, based on the motion cadence and the absolute times of the peaks 503, one or more future times of one or more respective future footfalls 501. In one or more implementations, determining (504) the motion cadence and the motion phase of the cyclic movement may include performing filtering operations (e.g., filtering high frequency or low frequency features out of the sensor data 599), tempo decimation operations, and/or hysteretic damping operations.

As indicated in FIG. 5, motion information 506 (e.g., a motion cadence, such as a cadence in footfalls per minute or other unit time, and/or a motion phase including one or more predicted future footfall times) may be used to obtain (510) an adjusted tempo and a phase for output of audio content. In one or more implementations, the adjusted tempo and the phase can be obtained for previously selected audio content, such as a user-selected song and/or a song in a previously selected playlist. In one or more other implementations, as shown in FIG. 5, a portion 506′ (e.g., the motion cadence) of the motion information 506 may be provided to an audio content source 500 (e.g., the memory 162, the first remote service 130 or the second remote source 160 of FIG. 1). In this example, the audio content source may curate (508) audio content for the electronic device 104 based on the portion 506′ of the motion information 506. For example, curating (508) the audio content may include selecting a song or a playlist of songs that have initial tempos within a predetermined range of the motion cadence. In this way, audio content can be curated by the audio content source 500 that can later be adjusted in tempo and/or phase to match the motion cadence and/or the motion phase of the user movement, without noticeably distorting or changing the overall sound and/or pitch of the audio content.

In the example of FIG. 5, in addition to the peaks 503 that indicate footfalls and footfall times, an electronic device 104 may extract additional characteristics of the user motion from the sensor data 599. For example, the electronic device may determine characteristics such as a footfall contact time (e.g., an amount of time during which the user's foot is in contact with the ground during each footfall) and/or a footfall contact force (e.g., a maximum or average/median force with which the user's foot contacts the ground for each footfall) during a walking, running, dancing or other motion by a user. As other examples, the electronic device may determine a smoothness factor that indicates a relative smoothness of the cyclic movement of the user (e.g., and that can distinguish between, for example, smooth transitions of a ballet dance and quick and forceful changes in a hip hop dance, even if the ballet dance and the hip hop dance are performed at the same tempo). In one or more implementations, the electronic device may determine, for example, that footfalls are heavy footfalls or light footfalls based on the footfall contact time and/or a footfall contact force. In one or more implementations, the electronic device 104 or audio content source 500 may determine (e.g., during content curation 508) a heavy style of music (e.g., rock music, heavy metal music, or rap music) or a light style of music (e.g., pop music or dance music) responsive to identifying the heavy or light footfalls, respectively, and provide a song or a playlist according to that determined style.

As shown in FIG. 5, whether audio content 509 is previously selected or curated by the audio content source 500, the electronic device 104 may obtain (510) the adjusted tempo and the phase for the output of audio content. The electronic device 104 may then provide the audio content 514 with the adjusted tempo and the phase for transmission (516) to the media output device 150 (e.g., over a wireless connection 518, such as a Bluetooth connection). As illustrated in FIG. 5, the electronic device 104 and the media output device 150 may also exchange latency information 512. For example, the media output device 150 may determine a transmission latency of the wireless connection 518, and may publish the transmission latency to the electronic device 104. For example, the transmission latency may be a delay time between transmission (516) of the audio content from the electronic device 104 to output of the audio content by the media output device 150, and the output of the audio content by the speaker of the media output device 150. The electronic device 104 may determine (510) the phase for output of the audio content in part based on the transmission latency. For example, the determination of the phase may include an advancement, in time, of the audio content 514 by an amount corresponding to the transmission latency, to cause the output (520) of the audio content to include beats that coincide temporally with the footfalls 501 of the user 101.

In one or more implementations, additional modifications to the tempo and/or the phase of the output of the audio content can be made to encourage an action of the user that the user has not yet performed. For example, the electronic device 104 may increase a tempo of the audio content to encourage an increase in a motion cadence of the movement of the user (e.g., to encourage the user to run or walk at a faster pace, to dance at a faster rate, and/or to increase their heartrate to a target heartrate for a workout or a portion thereof). As another example, the electronic device 104 may decrease a tempo of the audio content to encourage a decrease in a motion cadence of the movement of the user (e.g., to encourage the user to temporarily slow, or to begin winding down a walk, run, dance, or other workout, and/or to decrease their heartrate to a target heartrate or to a heartrate that is below a heartrate cap/limit for a workout or a portion thereof). As another example, the electronic device 104 may modify a style of the audio content to encourage a change in a characteristic of the movement of the user. For example, the content curation 508 may select a lighter style of music to encourage lighter footfalls during a run or a dance activity being performed by the user. In various implementations, the electronic device 104 may share (e.g., with another device of the user and/or with a server in an anonymized manner and with explicit permission from the user) motion information (e.g., tempo, footfall contact time, etc.) about an activity of the user (e.g., running, walking, dancing, gymnastics, household maintenance, gardening, construction, and/or any other repetitive motion that can be captured by sensors of the electronic device or another electronic device) to influence audio content selection such that the audio content is curated to accompany an activity.

FIG. 6 illustrates a flow diagram of an example process 600 for motion-based audio output, in accordance with implementations of the subject technology. For explanatory purposes, the process 600 is primarily described herein with reference to the media output device 150 and electronic device 104 of FIG. 1. However, the process 600 is not limited to the media output device 150 and electronic device 104 of FIG. 1, and one or more blocks (or operations) of the process 600 may be performed by one or more other components of other suitable devices and/or servers. Further for explanatory purposes, some of the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

As illustrated in FIG. 6, at block 602, an electronic device (e.g., the electronic device 104) may obtain motion sensor information (e.g., sensor data 599 of FIG. 5) from a sensor (e.g., sensor(s) 170) of the electronic device. As examples, the motion sensor information may include accelerometer data, gyroscope data, image sensor data and/or other remote sensor data, and/or motion information (e.g., footfall peaks, footfall times or the like) derived from the accelerometer data, gyroscope data, image sensor data and/or other remote sensor data.

At block 604, the electronic device may obtain audio content having an initial tempo. In one or more implementations, obtaining the audio content may include obtaining a playlist of songs each having a respective initial tempo within a range of the motion cadence. As examples, the playlist of songs may be curated at the electronic device (e.g., by a system process of the electronic device or by an application process at the electronic device) or by a remote service (e.g., the first remote service 130 or the second remote service 160 of FIG. 1), to only include songs or other audio content having a respective initial tempo within a predetermined range of the motion cadence.

In one or more implementations, the electronic device may also determine a characteristic of at least one of the plurality of respective footfalls, and determine a content style based on the characteristic. In these implementations, obtaining the audio content may include obtaining the audio content according to the content style. In one or more implementations, obtaining the audio content according to the content style may include obtaining the audio content based at least in part on a footfall contact time. For example, the electronic device may determine characteristics such as a footfall contact time and/or a footfall contact force during a walking, running, or dancing motion by a user. The electronic device may determine, for example, that footfalls are heavy footfalls or light footfalls based on the footfall contact time and/or a footfall contact force. The electronic device may determine a heavy style of music (e.g., rock music, heavy metal music, or rap music) or a light style of music (e.g., pop music or dance music) responsive to identifying the heavy or light footfalls, respectively. In some examples, heavy music may have more low frequency content (e.g., bass sounds, low frequency drums, etc.) than light music. In some examples, heavy music may include fewer notes per measure than light music. In some examples, heavy music may include more dissonant tones and/or minor key content than light music.

At block 606, the electronic device may determine, based on the motion sensor information, an adjusted tempo and a phase for output of the audio content. For example, determining the adjusted tempo and the phase may be performed, at least in part, by phase matching the phase for output of the audio content to a motion phase of a cyclic movement of a user of the electronic device. The motion phase may be captured from the motion sensor information. For example, the electronic device may determine, based on the motion sensor information, a motion cadence and the motion phase of the cyclic movement of the user of the electronic device. In one or more implementations, determining the adjusted tempo may include modifying the initial tempo of the audio content according to the motion cadence.

In one or more implementations, the cyclic movement includes a walking movement or a running movement, and determining the motion cadence and the motion phase includes identifying, based on the motion sensor information, a plurality of times (e.g., footfall times 200) of a plurality of respective footfalls (e.g., footfalls 202) of the user, and determining the motion cadence and the motion phase based at least in part on the identified plurality of times.

At block 608, the electronic device may provide the audio content for output with the adjusted tempo and the phase. For example, providing the audio content for output may include providing the audio content to a media output device (e.g., media output device 150) that is wirelessly connected (e.g., via wireless connection 518) to the electronic device, and the process 600 may also include obtaining, by the electronic device from the media output device, a transmission latency (e.g., latency information 512) corresponding to communication between the electronic device and the media output device. In one or more implementations, performing the phase matching may include determining the phase (e.g., for output of the audio content) based on the plurality of times and the transmission latency. For example, the initial tempo for output of the audio content may correspond to a number of beats (e.g., beats 204) per unit time (e.g., beats per minute, beats per second, beats per measure, etc.), and determining the adjusted tempo and the phase for output may include determining the adjusted tempo and the phase that cause the beats of the audio content to be output by the media output device at tempo-matched and phase-matched times (e.g., footfall times 200) that coincide with the plurality of times (e.g., footfall times 200) of the plurality of respective footfalls.

In one or more implementations, the process 600 may also include detecting, based on the motion sensor information from the sensor of the electronic device, a change in a motion cadence of the cyclic movement of the user; and slewing the adjusted tempo to track the change in the motion cadence.

In one or more implementations, providing the audio content for output with the adjusted tempo and the phase at block 608 may include providing a current track of the audio content for output with the adjusted tempo and the phase during the cyclic movement of the user, and the process 600 may also include, prior to an end of the output of the current track and prior to a beginning of an output of a next track of the audio content, matching a phase for output of the next track of the audio content to the motion phase of the cyclic movement of the user, and storing the beginning of the next track having the matched phase in a look-ahead buffer for the output of the next track. The process 600 may also include matching the tempo of the next track to correspond to a motion cadence of the cyclic movement.

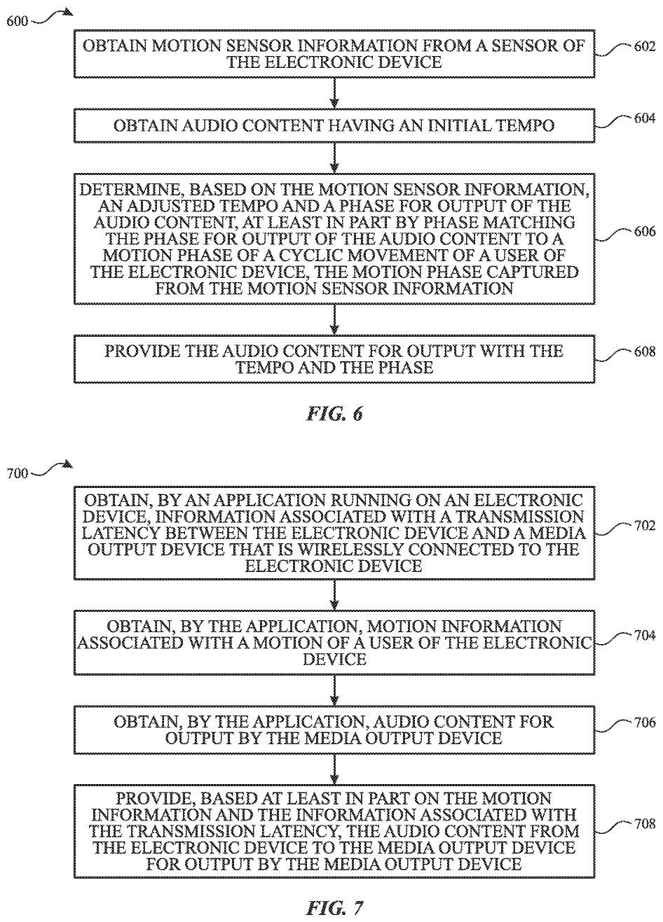

FIG. 7 illustrates a flow diagram of an example process 700 that may be performed by an application for motion-based audio output, in accordance with implementations of the subject technology. For explanatory purposes, the process 700 is primarily described herein with reference to the media output device 150 and electronic device 104 of FIG. 1. However, the process 700 is not limited to the media output device 150 and electronic device 104 of FIG. 1, and one or more blocks (or operations) of the process 700 may be performed by one or more other components of other suitable devices and/or servers. Further for explanatory purposes, some of the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

As illustrated in FIG. 7, at block 702, an application (e.g., an application 174) running on an electronic device, may obtain information associated with a transmission latency (e.g., latency information 512) between the electronic device and a media output device (e.g., media output device 150, such as headphones or an earbud) that is connected (e.g., via a wired connection or via a wireless connection, such as wireless connection 518) to the electronic device. In one or more implementations, obtaining the information associated with the transmission latency may include obtaining the transmission latency at the application from a system process (e.g., system process 172) at the electronic device. In one or more other implementations, obtaining the information associated with the transmission latency and obtaining the motion information may include obtaining a plurality of beat output times for the audio content from a system process (e.g., system process 172) at the electronic device, the beat output times determined by the system process based on the transmission latency and the motion information. For example, the beat output times may be the same as one or more predicted footfall times 200 that have been predicted, by the system process, based on a measured footfall cadence and a measured footfall phase during a motion (e.g., a movement such as a cyclic movement) of a user of the electronic device.

At block 704, the application may obtain motion information (e.g., sensor data 599 or motion information derived from the sensor data 599 by a system process at the electronic device) associated with a motion (e.g., a movement such as a cyclic movement) of a user of the electronic device. As examples, the motion information may include accelerometer data, gyroscope data, image sensor data and/or other remote sensor data, and/or motion information (e.g., footfall peaks, footfall times or the like) derived from the accelerometer data, gyroscope data, image sensor data and/or other remote sensor data.

At block 706, the application may obtain audio content for output by the media output device. For example, the audio content may be stored in memory (e.g., memory 162) at the electronic device, or may be obtained from a remote service (e.g., a streaming service, such as the first remote service 130 or the second remote service 160) of FIG. 1.

At block 708, the audio content may be provided, based at least in part on the motion information and the information associated with the transmission latency, from the electronic device to the media output device for output by the media output device. In one or more implementations, providing the audio content may include providing the audio content to the media output device, advanced in time according to the transmission latency, for tempo and phase synchronization with the motion of the user.

In one or more implementations, the process 700 may allow the electronic device and the media output device to generate and output audio content that is synchronized to the movement of the user (e.g., based on motion information that acts as feedback to the tempo and phase synchronization processes discussed herein). For example, the tempo and phase synchronization with the motion of the user may include a synchronization of a tempo of the audio content with a motion cadence of the motion of the user and a synchronization of a phase of the audio content with a motion phase of the motion of the user.

In one or more implementations, providing the audio content from the electronic device to the media output device for output by the media output device based at least in part on the motion information and the information associated with the transmission latency may include: modifying the audio content (e.g., by performing time compression or time expansion operations) based on the motion information and the information associated with the transmission latency to generate modified audio content, and providing the modified audio content to the media output device. In one or more other implementations, providing the audio content from the electronic device to the media output device for output by the media output device based at least in part on the motion information and the information associated with the transmission latency may include modifying the output of the audio content based on the motion information and the information associated with the transmission latency (e.g., without modifying the audio content itself, such as by speeding, slowing, and/or translating the output of the unmodified audio content).

In one or more implementations, additional modifications to the tempo and/or the phase of the output of the audio content can be made to encourage an action of the user that the user has not yet performed. For example, the application or the system process can increase a tempo of the audio content to encourage an increase in a motion cadence of the motion of the user (e.g., to encourage the user to run or walk at a faster pace, or to dance at a faster rate). As another example, the application or the system process can decrease a tempo of the audio content to encourage a decrease in a motion cadence of the motion of the user (e.g., to encourage the user to temporarily slow, or to begin winding down a walk, run, dance, or other workout). As another example, the application or the system process may modify a style of the audio content to encourage a change in a characteristic of the motion of the user. For example, the application or the system process may select a lighter style of music to encourage lighter footfalls during a run or a dance activity being performed by the user.

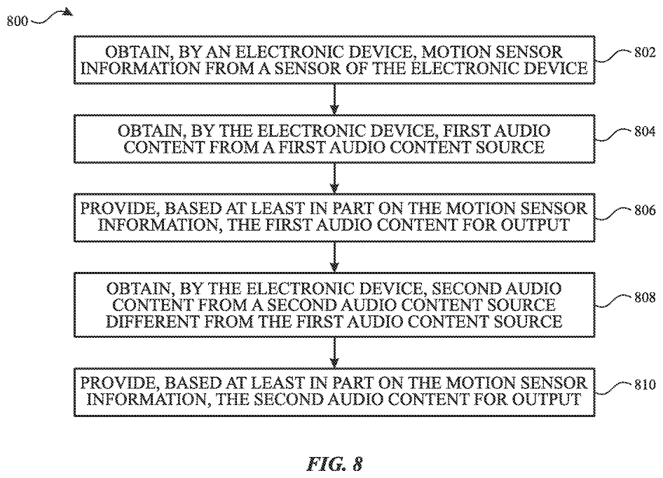

FIG. 8 illustrates a flow diagram of an example process 800 for operating an electronic device, in accordance with implementations of the subject technology. For explanatory purposes, the process 800 is primarily described herein with reference to the media output device 150 and electronic device 104 of FIG. 1. However, the process 800 is not limited to the media output device 150 and electronic device 104 of FIG. 1, and one or more blocks (or operations) of the process 800 may be performed by one or more other components of other suitable devices and/or servers. Further for explanatory purposes, some of the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

As illustrated in FIG. 8, at block 802, an electronic device (e.g., electronic device 104) may obtain motion sensor information (e.g., sensor data 599 or information derived therefrom) from a sensor (e.g., sensor 170) of the electronic device. As examples, the motion sensor information may include accelerometer data, gyroscope data, image sensor data and/or other remote sensor data, and/or motion information (e.g., footfall peaks, footfall times or the like) derived from the accelerometer data, gyroscope data, image sensor data and/or other remote sensor data.

At block 804, the electronic device may obtain first audio content from a first audio content source. For example, the electronic device may obtain a first song or a first playlist from the first audio content source (e.g., the memory 162 or the first remote service 130). The audio content may be obtained by a system process at the electronic device or by an application running at the electronic device.

At block 806, the electronic device may provide, based at least in part on the motion sensor information, the first audio content (e.g., to one or more audio output components of the electronic device or another device such as the media output device 150) for output (e.g., by the one or more audio output components of electronic device or another device, such as the media output device 150). For example, providing the first audio content for output may include determining a first tempo and a first phase for output of the first audio content based on the motion sensor information (e.g., a first tempo and a first phase corresponding to a motion cadence and a motion phase of a movement of a user of the electronic device, as included in or derived from the motion sensor information). In one or more implementations, determining the first phase of the first audio content may include determining the first phase based in part on a transmission latency (e.g., latency information 512) between the electronic device and a media output device (e.g., media output device 150). In one or more implementations, providing the first audio content for output may include providing the first audio content to the media output device for output by the media output device (e.g., by one or more speakers of the media output device). In one or more implementations, determining the first phase may include phase-matching the first phase to footfalls of a user of the electronic device.

At block 808, the electronic device may obtain second audio content (e.g., a second song or a second playlist) from a second audio content source (e.g., second remote source 160) different from the first audio content source. In one illustrative example, the first audio content source includes memory (e.g., memory 162) at the electronic device, and the second audio content source includes a remote service (e.g., first remote service 130). In another illustrative example, the first audio content source includes a first remote service (e.g., first remote service 130), and the second audio content source includes a second remote service (e.g., second remote source 160) different from the first remote service.

At block 810, the electronic device may provide, based at least in part on the motion sensor information, the second audio content for output (e.g., by the one or more audio output components of electronic device or another device, such as the media output device 150). For example, providing the second audio content for output may include determining a second tempo and a second phase of the second audio content based on the motion sensor information (e.g., a second tempo and a second phase corresponding to the motion cadence and the motion phase of the movement of the user of the electronic device, as included in or derived from the motion sensor information). In one or more implementations, determining the second phase of the second audio content may include determining the second phase based in part on the transmission latency (e.g., latency information 512) between the electronic device and the media output device. In one or more implementations, providing the second audio content for output may include providing the second audio content to the media output device for output by the media output device (e.g., by one or more speakers of the media output device). In one or more implementations, determining the second phase may include phase-matching the second phase to footfalls of a user of the electronic device.

In one or more implementations, obtaining the first audio content at block 804 includes obtaining the first audio content from at a system process (e.g., system process 172) of the electronic device from the first remote service via a first application process (e.g., a first application 174) at the electronic device and obtaining the second audio content includes obtaining the second audio content at the system process of the electronic device from the second remote service via a second application process (e.g., a second application 174) at the electronic device. For example, the first application process may be a process of a first application associated with (e.g., provided by) the first remote service, and the second application process may be a process of a second application associated with (e.g., provided by) the second remote service. For example, the user of the electronic device may be using the first application to stream music from a first remote music service, stop streaming the music with the first application, and use the second application for streaming music from another remote music service. The subject technology provides the advantage that the system process can perform tempo and/or phase synchronization with user motion for music or other audio content from any of various streaming services and/or for music stored at the electronic device.

In one or more implementations, providing the first audio content for output at block 806 may include determining, by the system process and based on the motion sensor information, a cadence and a phase of a cyclic movement of a user of the electronic device; performing, by the system process, first tempo matching to match a tempo of the first audio content to the cadence of a cyclic movement; and performing, by the system process, first phase matching to match a phase of the first audio content to the phase of the cyclic movement. In one or more implementations, providing the second audio content for output may include determining, by the system process and based on the motion sensor information, an updated cadence and an updated phase of the cyclic movement of the user of the electronic device; performing, by the system process, second tempo matching to adjust a tempo of the second audio content to the updated cadence of the cyclic movement; and performing, by the system process, second phase matching to match a phase of the second audio content to the updated phase of the cyclic movement.

In various implementations, the second tempo may be the same as or different from the first tempo, and/or the second phase may be the same as or different from the first phase, depending on whether the user's motion has changed between providing the first content and the second content for output.

FIG. 9 illustrates a flow diagram of an example process 900 in accordance with implementations of the subject technology. For explanatory purposes, the process 900 is primarily described herein with reference to the media output device 150 and electronic device 104 of FIG. 1. However, the process 900 is not limited to the media output device 150 and electronic device 104 of FIG. 1, and one or more blocks (or operations) of the process 900 may be performed by one or more other components of other suitable devices and/or servers. Further for explanatory purposes, some of the blocks of the process 900 are described herein as occurring in serial, or linearly. However, multiple blocks of the process 900 may occur in parallel. In addition, the blocks of the process 900 need not be performed in the order shown and/or one or more blocks of the process 900 need not be performed and/or can be replaced by other operations.

In the example of FIG. 9, at block 902, an electronic device (e.g., electronic device 104) may determine a footfall contact time of a wearer of the electronic device during an activity (e.g., a cyclic movement, such as running, jogging, walking, swimming, dancing, cycling, vacuuming, sawing, hammering, raking, gymnastics, or the like) being performed by the wearer. For example, the footfall contact time may be an amount of time the wearer's foot is in contact with the ground during each of a multiple footfalls during the activity being performed by the wearer. Determining the footfall contact time may include determining the footfall contact time using one or more sensors of the electronic device and/or one or more sensors of one or more other electronic devices.

At block 904, the electronic device may obtain audio content based at least in part on the footfall contact time. For example, obtaining the audio content may include obtaining the audio content from a content curation service at a remote server (e.g., by providing the footfall contact time to the remote server, in an anonymized manner and with explicit permission from the wearer), or may include curating the audio content from audio content stored at the electronic device based on the footfall contact time.

At block 906, the electronic device may output (e.g., via a speaker of the electronic device or by providing the audio content to another device having a speaker for output) the audio content during the activity being performed by the wearer. In one or more implementations, the method 900 may also include synchronizing a tempo and a phase of the output of the audio content with the plurality of footfalls (e.g., as described herein in connection with FIGS. 6-8).

As described above, one aspect of the present technology is the gathering and use of data available from specific and legitimate sources for training and/or operating machine learning models. The present disclosure contemplates that in some instances, this gathered data may include personal information data that uniquely identifies or can be used to identify a specific person. Such personal information data can include audio data, voice samples, voice profiles, demographic data, location-based data, online identifiers, telephone numbers, email addresses, home addresses, biometric data or records relating to a user's health or level of fitness (e.g., vital signs measurements, medication information, exercise information, motion information, workout information), date of birth, or any other personal information.

The present disclosure recognizes that the use of such personal information data, in the present technology, can be used to the benefit of users. For example, the personal information data can be used for motion-based audio curation and/or output.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates aspects in which users selectively block the use of, or access to, personal information data. That is, the present disclosure contemplates that hardware and/or software elements can be provided to prevent or block access to such personal information data. For example, in the example of motion-based audio output, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data.

FIG. 10 illustrates an electronic system 1000 with which one or more implementations of the subject technology may be implemented. The electronic system 1000 can be, and/or can be a part of, the media output device 150, the electronic device 104, the server(s) 120, and/or the server(s) 140 as shown in FIG. 1. The electronic system 1000 may include various types of computer readable media and interfaces for various other types of computer readable media. The electronic system 1000 includes a bus 1008, one or more processing unit(s) 1012, a system memory 1004 (and/or buffer), a ROM 1010, a permanent storage device 1002, an input device interface 1014, an output device interface 1006, and one or more network interfaces 1016, or subsets and variations thereof.

The bus 1008 collectively represents all system, peripheral, and chipset buses that communicatively connect the numerous internal devices of the electronic system 1000. In one or more implementations, the bus 1008 communicatively connects the one or more processing unit(s) 1012 with the ROM 1010, the system memory 1004, and the permanent storage device 1002. From these various memory units, the one or more processing unit(s) 1012 retrieves instructions to execute and data to process in order to execute the processes of the subject disclosure. The one or more processing unit(s) 1012 can be a single processor or a multi-core processor in different implementations.

The ROM 1010 stores static data and instructions that are needed by the one or more processing unit(s) 1012 and other modules of the electronic system 1000. The permanent storage device 1002, on the other hand, may be a read-and-write memory device. The permanent storage device 1002 may be a non-volatile memory unit that stores instructions and data even when the electronic system 1000 is off. In one or more implementations, a mass-storage device (such as a magnetic or optical disk and its corresponding disk drive) may be used as the permanent storage device 1002.

In one or more implementations, a removable storage device (such as a floppy disk, flash drive, and its corresponding disk drive) may be used as the permanent storage device 1002. Like the permanent storage device 1002, the system memory 1004 may be a read-and-write memory device. However, unlike the permanent storage device 1002, the system memory 1004 may be a volatile read-and-write memory, such as random access memory. The system memory 1004 may store any of the instructions and data that one or more processing unit(s) 1012 may need at runtime. In one or more implementations, the processes of the subject disclosure are stored in the system memory 1004, the permanent storage device 1002, and/or the ROM 1010 (which are each implemented as a non-transitory computer-readable medium). From these various memory units, the one or more processing unit(s) 1012 retrieves instructions to execute and data to process in order to execute the processes of one or more implementations.

The bus 1008 also connects to the input and output device interfaces 1014 and 1006. The input device interface 1014 enables a user to communicate information and select commands to the electronic system 1000. Input devices that may be used with the input device interface 1014 may include, for example, alphanumeric keyboards and pointing devices (also called “cursor control devices”). The output device interface 1006 may enable, for example, the display of images generated by electronic system 1000. Output devices that may be used with the output device interface 1006 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 10, the bus 1008 also couples the electronic system 1000 to one or more networks and/or to one or more network nodes through the one or more network interface(s) 1016. In this manner, the electronic system 1000 can be a part of a network of computers (such as a LAN, a wide area network (“WAN”), or an Intranet, or a network of networks, such as the Internet. Any or all components of the electronic system 1000 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In accordance with aspects of the disclosure, a method is provided that includes, by an electronic device, obtaining motion sensor information from a sensor of the electronic device; obtaining audio content having an initial tempo; determining, based on the motion sensor information, an adjusted tempo and a phase for output of the audio content, at least in part by phase matching the phase for output of the audio content to a motion phase of a cyclic movement of a user of the electronic device, the motion phase captured from the motion sensor information; and providing the audio content for output with the adjusted tempo and the phase.

In accordance with aspects of the disclosure, a method is provided that includes obtaining, by an application running on an electronic device, information associated with a transmission latency between the electronic device and a media output device that is connected to the electronic device; obtaining, by the application, motion information associated with a motion of a user of the electronic device; obtaining, by the application, audio content for output by the media output device; and providing, based at least in part on the motion information and the information associated with the transmission latency, the audio content from the electronic device to the media output device for output by the media output device.

In accordance with aspects of the disclosure, a method is provided that includes obtaining, by an electronic device, motion sensor information from a sensor of the electronic device; obtaining, by the electronic device, first audio content from a first audio content source; providing, based at least in part on the motion sensor information, the first audio content for output; obtaining, by the electronic device, second audio content from a second audio content source different from the first audio content source; and providing, based at least in part on the motion sensor information, the second audio content for output.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention described herein.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

What is claimed is:

1. A method, comprising, by an electronic device:
obtaining motion sensor information from a sensor of the electronic device;
obtaining audio content having an initial tempo;
determining, based on the motion sensor information, an adjusted tempo and a phase for output of the audio content, at least in part by phase matching the phase for output of the audio content to a motion phase of a cyclic movement of a user of the electronic device, the motion phase captured from the motion sensor information; and
providing the audio content for output with the adjusted tempo and the phase.

2. The method of claim 1, further comprising determining, by the electronic device and based on the motion sensor information, a motion cadence and the motion phase of the cyclic movement of the user of the electronic device, wherein determining the adjusted tempo comprises modifying the initial tempo of the audio content according to the motion cadence.

3. The method of claim 2, wherein the cyclic movement comprises a walking movement or a running movement, and wherein determining the motion cadence and the motion phase comprise:
identifying, based on the motion sensor information, a plurality of times of a plurality of respective footfalls of the user; and
determining the motion cadence and the motion phase based at least in part on the identified plurality of times.

4. The method of claim 3, wherein providing the audio content for output comprises providing the audio content to a media output device that is wirelessly connected to the electronic device, the method further comprising:
obtaining, by the electronic device from the media output device, a transmission latency corresponding to communication between the electronic device and the media output device, wherein performing the phase matching comprises determining the phase based on the plurality of times and the transmission latency.

5. The method of claim 4, wherein the initial tempo for output of the audio content corresponds to a number of beats per unit time, and wherein determining the adjusted tempo and the phase for output comprises determining the adjusted tempo and the phase that cause the beats of the audio content to be output by the media output device at tempo-matched and phase-matched times that coincide with the plurality of times of the plurality of respective footfalls.

6. The method of claim 3, further comprising:
determining a characteristic of at least one of the plurality of respective footfalls; and
determining a content style based on the characteristic, wherein obtaining the audio content comprises obtaining the audio content according to the content style.

7. The method of claim 6, wherein the characteristic comprises footfall contact time of the at least one of the plurality of respective footfalls, and wherein obtaining the audio content according to the content style comprises obtaining the audio content based at least in part on the footfall contact time.

8. The method of claim 2, wherein obtaining the audio content comprises obtaining a playlist of songs each having a respective initial tempo within a range of the motion cadence.

9. The method of claim 1, further comprising:
detecting, based on the motion sensor information from the sensor of the electronic device, a change in a motion cadence of the cyclic movement of the user; and
slewing the adjusted tempo to track the change in the motion cadence.

10. The method of claim 1, wherein providing the audio content for output with the adjusted tempo and the phase comprises providing a current track of the audio content for output with the adjusted tempo and the phase during the cyclic movement of the user, the method further comprising:
prior to an end of the output of the current track and prior to a beginning of an output of a next track of the audio content, matching a phase for output of the next track of the audio content to the motion phase of the cyclic movement of the user and storing the beginning of the next track having the matched phase in a look-ahead buffer for the output of the next track.

11. A non-transitory machine-readable medium storing instructions which, when executed by one or more processors, cause the one or more processors to perform operations comprising:
obtaining, by an application running on an electronic device, information associated with a transmission latency between the electronic device and a media output device that is connected to the electronic device;
obtaining, by the application, motion information associated with a motion of a user of the electronic device;
obtaining, by the application, audio content for output by the media output device; and
providing, based at least in part on the motion information and the information associated with the transmission latency, the audio content from the electronic device to the media output device for output by the media output device.

12. The non-transitory machine-readable medium of claim 11, wherein obtaining the information associated with the transmission latency comprises obtaining the transmission latency at the application from a system process at the electronic device.

13. The non-transitory machine-readable medium of claim 11, wherein obtaining the information associated with the transmission latency and obtaining the motion information comprise obtaining a plurality of beat output times for the audio content from a system process at the electronic device, the beat output times determined by the system process based on the transmission latency and the motion information.

14. The non-transitory machine-readable medium of claim 11, wherein providing the audio content comprises providing the audio content to the media output device, advanced in time according to the transmission latency, for tempo and phase synchronization with the motion of the user.

15. The non-transitory machine-readable medium of claim 14, the operations further comprising increasing a tempo of the audio content to encourage an increase in a motion cadence of the motion of the user.

16. The non-transitory machine-readable medium of claim 14, the operations further comprising modifying a style of the audio content to encourage a change in a characteristic of the motion of the user.

17. The non-transitory machine-readable medium of claim 14, wherein the tempo and phase synchronization with the motion of the user comprises a synchronization of a tempo of the audio content with a motion cadence of the motion of the user and a synchronization of a phase of the audio content with a motion phase of the motion of the user.

18. The non-transitory machine-readable medium of claim 11, wherein providing the audio content from the electronic device to the media output device for output by the media output device based at least in part on the motion information and the information associated with the transmission latency comprises:
modifying the audio content based on the motion information and the information associated with the transmission latency to generate modified audio content; and
providing the modified audio content to the media output device.

19. The non-transitory machine-readable medium of claim 11, wherein providing the audio content from the electronic device to the media output device for output by the media output device based at least in part on the motion information and the information associated with the transmission latency comprises:
modifying the output of the audio content based on the motion information and the information associated with the transmission latency.

20. The non-transitory machine-readable medium of claim 11, wherein the media output device is wirelessly connected to the electronic device.

21. An electronic device, comprising:
a memory; and
one or more processors configured to:
obtain, from a sensor of the electronic device, motion sensor information;
obtain, from a first audio content source, first audio content;
provide, based at least in part on the motion sensor information, the first audio content to one or more audio output components coupled to the electronic device for output;
obtain, from a second audio content source different from the first audio content source, second audio content; and
provide, based at least in part on the motion sensor information, the second audio content to the one or more audio output components coupled to the electronic device for output.

22. The electronic device of claim 21, wherein the one or more processors are configured to provide the first audio content for output, in part, by determining a first tempo and a first phase for output of the first audio content based on the motion sensor information, and to provide the second audio content for output, in part, by determining a second tempo and a second phase of the second audio content based on the motion sensor information.

23. The electronic device of claim 22, wherein the one or more processors are configured to determine the first phase of the first audio content and determine the second phase of the second audio content in part by determining the first phase and the second phase based in part on a transmission latency between the electronic device and a media output device that is separate from the electronic device and that comprises the one or more audio output components.

24. The electronic device of claim 23, wherein the one or more processors are configured to provide the first audio content to the one or more audio output components for output and provide the second audio content to the one or more audio output components for output by wirelessly transmitting the first audio content and the second audio content to the media output device for output by the one or more audio output components of the media output device.

25. The electronic device of claim 21, wherein the first audio content source comprises memory at the electronic device, and wherein the second audio content source comprises a remote service.

26. The electronic device of claim 21, wherein the first audio content source comprises a first remote service, and wherein the second audio content source comprises a second remote service different from the first remote service.

27. The electronic device of claim 26, wherein the one or more processors are configured to:
obtain the first audio content from at a system process of the electronic device from the first remote service via a first application process at the electronic device,
obtain the second audio content at the system process of the electronic device from the second remote service via a second application process at the electronic device,
provide the first audio content for output in part by:
determining, by the system process and based on the motion sensor information, a cadence and a phase of a cyclic movement of a user of the electronic device;
performing, by the system process, first tempo matching to match a tempo of the first audio content to the cadence of a cyclic movement; and
performing, by the system process, first phase matching to match a phase of the first audio content to the phase of the cyclic movement, and
provide the second audio content for output in part by:
determining, by the system process and based on the motion sensor information, an updated cadence and an updated phase of the cyclic movement of the user of the electronic device;
performing, by the system process, second tempo matching to adjust a tempo of the second audio content to the updated cadence of the cyclic movement; and
performing, by the system process, second phase matching to match a phase of the second audio content to the updated phase of the cyclic movement.

28. The electronic device of claim 21, further comprising a housing, wherein the one or more audio output components are disposed within the housing of the electronic device.

29. The electronic device of claim 21, further comprising a first housing, wherein the one or more audio output components are disposed in a second housing that is physically separate from the first housing.

30. A method, comprising:
determining a footfall contact time of a wearer of an electronic device during an activity being performed by the wearer;
obtaining, by the electronic device, audio content based at least in part on the footfall contact time; and
outputting the audio content during the activity being performed by the wearer.

31. The method of claim 30, wherein the footfall contact time comprises an amount of time a foot of the wearer is in contact with ground during each of a plurality of footfalls during the activity being performed by the wearer.

32. The method of claim 31, further comprising synchronizing a tempo and a phase of the output of the audio content with the plurality of footfalls.
